(19) United States
(12) Patent Application Publication
(10) Pub. No.: US 2003/0081017 A1
(43) Pub. Date: May 1, 2003

(54) System and method for dynamically managing language changes

(76) Inventors: Hossein Shenassa, Calgary (CA); Bertrand Michaud, Kanata (CA)

Correspondence Address: Fay Kaplun & Marcin, LLP, 150 Broadway, Suite 702, New York, NY, 10038, US

(21) Appl. No.: 10/045,538

(22) Filed: Oct. 18, 2001

(51) Int. Cl. G09G 5/00

(52) U.S. Cl. 345/866

(57) ABSTRACT

A method comprising the steps of setting a language for an application, registering components on a list of listeners when the components are to be displayed by the application, wherein the components have a language setting, changing the language setting of each component on the list of listeners to the language for the application when the language setting is different from the language for the application and displaying the components in the language for the application.

### BACKGROUND INFORMATION

Many devices such as personal computers (“PCs”), servers, internet devices, embedded devices (e.g., personal digital assistants (“PDAs”), mobile telephones, home appliances, security devices, etc.) contain application software to perform functions requested by a user. In order to interact effectively with the user of the device, the application programs provide for visual output on the device's output modules, e.g., cathode ray tubes (“CRTs”), liquid crystal displays (“LCDs”), touch-screens, etc. Some of these visual outputs are referred to as graphical user interfaces (“GUIs”). A typical embedded device may display a graphical user interface to allow the user to interact with the application program and control the device. The graphical user interface is built of graphical elements called components. Typical components include such items as buttons, scrollbars, and text fields. Components allow the user to interact with the program and provide the user with visual feedback about the state of the program.

### SUMMARY OF THE INVENTION

A method comprising the steps of setting a language for an application, registering components on a list of listeners when the components are to be displayed by the application, wherein the components have a language setting, changing the language setting of each component on the list of listeners to the language for the application when the language setting is different from the language for the application and displaying the components in the language for the application. In addition, a method comprising the steps of registering a graphical user interface component with a language manager, changing a language setting of the component to a first language contained in the language manager when the component is registered with the language manager and displaying the component in the first language contained in the language manager.

Furthermore, a system comprising a plurality of resource bundles containing language specific information, each set of resource bundles corresponding to a predetermined language, a graphical user interface component to be displayed on an output arrangement, wherein the component retrieves language specific information from the plurality of resource bundles and a language manager containing a language setting for an application, wherein the component is registered with the language manager when the component is to be displayed and the language manager provides the component with access to the set of resource bundles corresponding to the language setting.

### BRIEF DESCRIPTION OF DRAWINGS

FIG. 1 shows an exemplary button component for use on a graphical user interface according to the present invention;

FIG. 2 shows an exemplary pull down menu component for use on a graphical user interface according to the present invention;

FIG. 3 shows an exemplary scroll bar component for use on a graphical user interface according to the present invention;

FIG. 4 shows exemplary text box and label component for use on a graphical user interface according to the present invention;

FIG. 5 shows an exemplary menu bar component for use on a graphical user interface according to the present invention;

FIG. 6 shows an exemplary graphical user interface screen which may be displayed on a device according to the present invention;

FIG. 7a shows a diagram illustrating the exemplary interaction between a language manager, a GUI, and a toolkit when a GUI component is being made displayable according to the present invention;

FIG. 7b shows a diagram illustrating the exemplary interaction between a language manager, a GUI, and a toolkit when a GUI component is being made undisplayable according to the present invention;

FIG. 8 is an exemplary diagram showing a graphical user interface component tied to resource bundles according to the present invention;

FIG. 9 shows exemplary resource bundles using parameter keys and values to store different languages for a graphical user interface component according to the present invention;

FIG. 10a shows an exemplary graphical user interface component displaying values in English according to the present invention;

FIG. 10b shows the graphical user interface component of FIG. 10a displaying values in Spanish according to the present invention;

FIG. 10c shows an exemplary graphical user interface component displaying values in English according to the present invention;

FIG. 11a shows an exemplary process for displaying components on a graphical user interface according to the present invention;

FIG. 11b shows an exemplary process for undisplaying components on a graphical user interface according to the present invention;

FIG. 12 shows an exemplary process for loading the appropriate resource bundle(s) when the user changes the display language according to the present invention.

### DETAILED DESCRIPTION

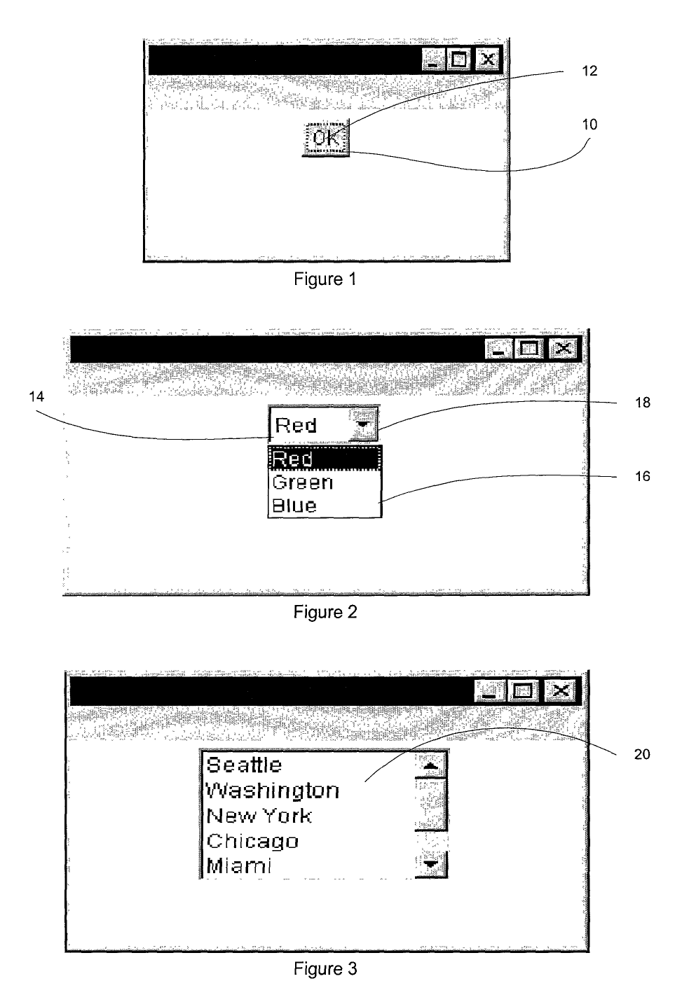

The present invention may be further understood with reference to the following description of preferred exemplary embodiments thereof and the appended drawings, wherein like elements are provided with the same reference numerals. FIGS. 1 through 5 are examples of components that may be displayed on a graphical user interface (“GUI”) of a software application. The exemplary embodiments shown in FIGS. 1 through 5 may be found in, for example, the Abstract Windowing Toolkit (“AWT”) available from Sun Microsystems, Inc. of Santa Clara, Calif. or other similar toolkits used for building GUIs. The exemplary embodiment of the present invention will be described with reference to AWT components, but those skilled in the art will understand that the present invention is applicable to any components that may be used to construct a GUI. Additionally, it should be understood that the present invention may be implemented in any processor or controller based device such as PCs, servers, PDAs, embedded devices, etc., and development platforms for the same. The term devices will be used throughout this description to generically refer to all such devices.

When components are displayed on a GUI, the application program, for which the GUI is displayed, monitors the input devices (e.g. keyboard, keypad, mouse, touchscreen, etc.) for user interaction with the GUI. For example, the application program waits for a user to press a key, click or move the mouse, or any other system-level event that affects the GUI. Some components may require the user to input a word or sentence, others may require the user to make a selection from available choices, and others may be signals or messages to indicate the status of the application program to the user and do not require any user input.

FIG. 1 shows a first exemplary GU component, a button 10, which may act as a switch or a signal to the application program to continue processing. Each of the components on a GUI may be associated with some underlying functionality for the application program. For example, when a user is finished with the current screen and is ready to continue with the program, the user may activate the button 10 by clicking a mouse or touching the screen. The functionality associated with the button 10 indicates to the application program to continue processing (e.g., by displaying the next screen). The component may be configured to contain a written message 12 that informs the user of the functionality associated with the button 10. In this example, the use of the written message “OK” indicates to the user that the program will continue to operate only after the user activates the button 10.

FIG. 2 shows a second example of a GUI component, a pull down menu 14, which allows the user to select one option from a list. The user may display the entire list 16 by clicking on the down arrow 18. When an option is selected, it is displayed in the main window of the pull down menu 14 and the list 16 is removed from view.

FIG. 3 shows a third exemplary GUI component, a scroll bar menu 20, which is a menu that is always visible, as opposed to the hidden list 16 of the pull down menu 14 in FIG. 2. The user may select one or multiple options from the scroll bar menu 20. The options selected by the user may be displayed in bold or highlighted. When the user is done selecting the desired options from the scroll bar menu 20, the user may activate another component such as a button 10 to continue with the application program.

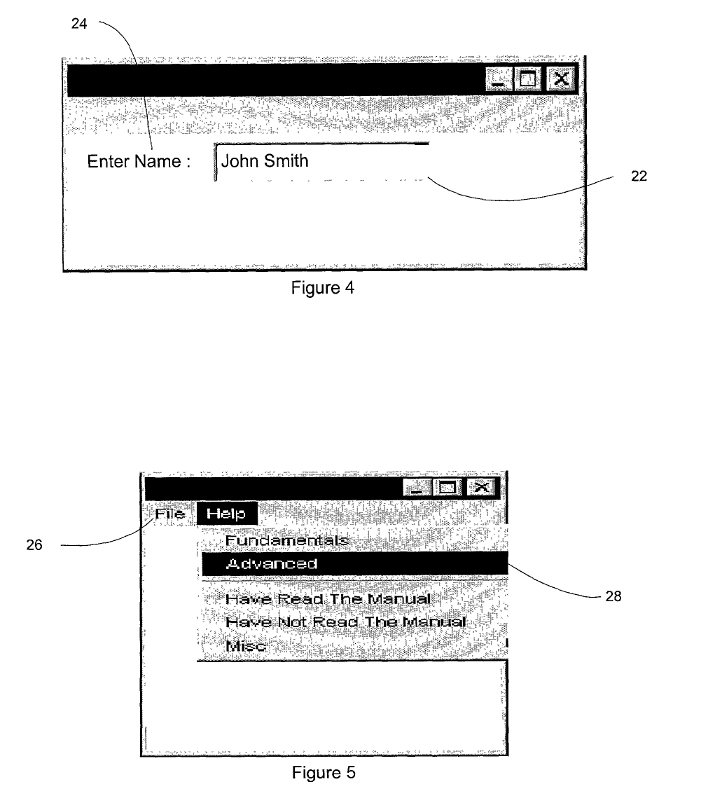

FIG. 4 shows two exemplary GUI components, a text field 22 and a label 24. The label 24 is generally a static message displayed to the user to convey instructions or inform the user of the current status of the application program. For example, the label 24 may contain the message “Enter Name”, indicating that the user's name should be entered in the GUI. The text field 22 is the GUI component into which the user may enter the requested information (e.g. user's name). The information entered by the user into text field 22 may then be processed and used by the application program.

FIG. 5 shows an exemplary GU component, a menu bar 26, which may contain multiple hidden lists 28, each with their own group of options. The options for each list 28 remain hidden until the name of the list 28 is activated by the user. Once an option has been selected, the list 28 disappears from view and the application program processes the option.

Those skilled in the art will understand that the GUI components shown in FIGS. 1 through 5 are only exemplary and there are numerous other components that developers may use to construct a GUI for an application program. For example, developers may also use GUI components such as checkboxes and text areas. Users of application programs which include GUIs are generally familiar with the operation and underlying functionality of the GUI components or are instructed via, for example, messages on the GUI, as to the operation of the GUI components.

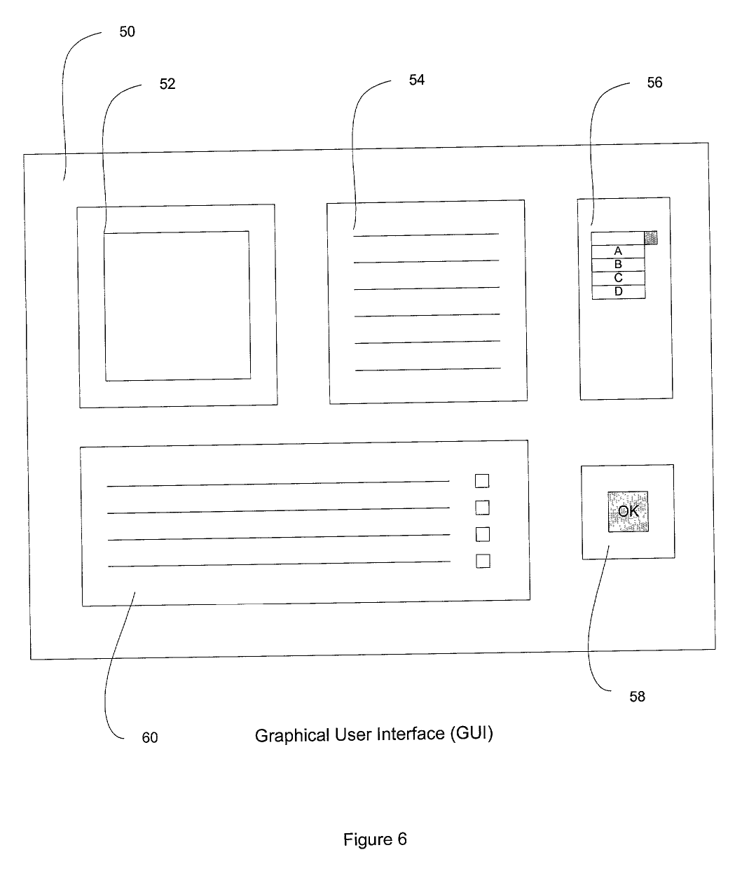

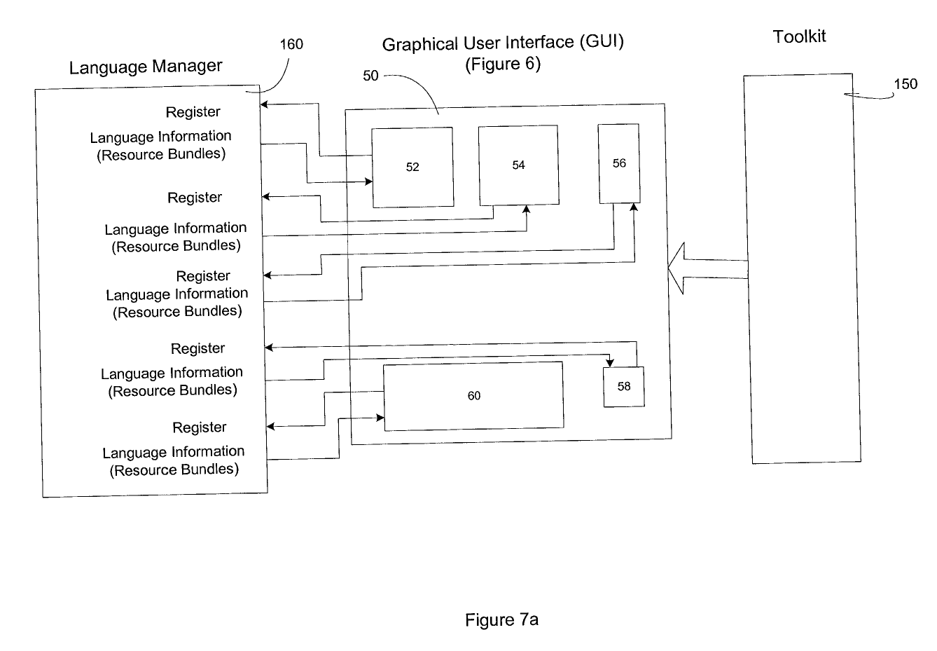

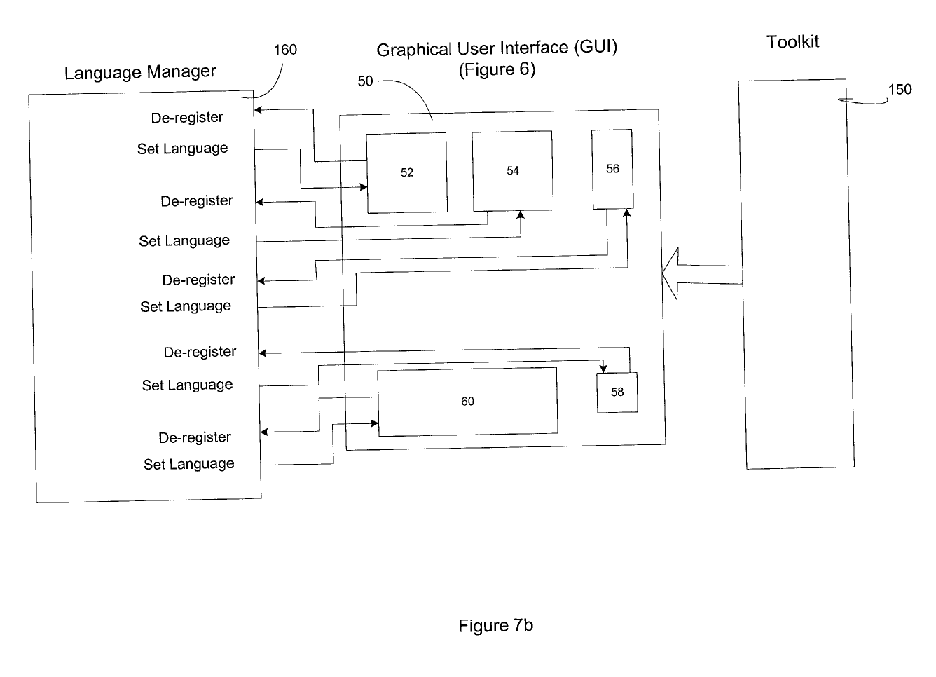

FIG. 6 is an exemplary GUI 50 which may be displayed on a device running an application program. Visible in the exemplary GUI are text area 52, label 54, pull down menu 56, button 58, and checkbox 60 components. The exemplary GUI 50 shows that multiple GUI components may be displayed in one GUI screen. In the GUI 50, the user may type an entry in the text area 52, the user may pick an item from the pull down menu 56 or the user may pick an item from the checkbox 60. The label 54 may instruct the user on how to activate each component and the result of activating each one. The button 58 may be activated when the user is finished with the components on this screen and desires to proceed to the next action to be carried out by the application program (e.g., process entered information, display the next GUI screen, etc.).

As described above, each of components 52-60 of the GUI 50 may have associated text or messages indicating various information to the user, such as, the functionality of the component, the status of the application program or GUI, the options available to the user, etc. Developers of the application program recognize that the device on which the application program is resident may ultimately be in any number of communities or countries which include a diverse blend of languages. To provide for these circumstances, the developers may provide the text or messages associated with the components in any number of different languages to accommodate the different users. Those skilled in the art will understand that there are numerous methods of providing for a component to be displayed in multiple languages. For example, a component may include multiple images with each image being in a different language. Depending on the language selected by the user, the component will display the appropriate image. Another example may be that the component has a database of phrases in multiple languages that may be substituted into the component based on the language selected by the user.

The exemplary embodiment of the present invention implements a language manager and uses the default behavior of a toolkit to manage the text and messages that may be provided in multiple languages for the GUI components (e.g. GUI components 52-60 of GUI 50). The language manager may be implemented, for example, as a Java class, procedure, routine, etc.. When GUI 50 is being prepared to be displayed to the user, the toolkit calls a method on the component to make each of the components 52-60 visible to the user. An exemplary method that performs such a function is the Java method addNotify( ) of the component. In addition, each of the components 52-60 also registers with the language manager so that it is notified if the language is changed. The following is an exemplary method that maybe implemented to register the components 52-60 with the language manager. The standard method addNotify( ) of the component is overridden so that it performs the component registration with the language manager:

public void addNotify() {

super.addNotify();
langMgr.addLanguageChangedListener( this );

}

This method of the component may be automatically called by the toolkit when the component is to be displayed to the user. The code of interest is the second line of the method where the component registers with the language manager as a listener to language change events. The language manager then adds this component to its list of listeners which are to be notified if a language change occurs. Also, if the language of the component (i.e., the language with which the component was last displayed, if any) is different than the current language, the language manager notifies the component of the change and the component will then display itself in the current language.

FIG. 7a is an exemplary diagram showing the interaction between the language manager 160, GUI 50, and the toolkit 150 when GUI 50 is being made displayable to a user. When the application program is preparing to display GUI 50, the toolkit 150 calls a method on each component to make the component visible on the GUI 50 (e.g., the addNotify( ) method). Each component 52-60 of GUI 50 in turn calls a method on the language manager 160 (e.g., by overriding the addNotify( ) method) to register itself as a listener with the language manager. An exemplary method for providing this function is described above.

The language manager 160 contains the setting for the current language preference. When a component is registered with the language manager 160, the language manager 160 queries the registered component for its language setting and if the current language setting of the application program does not equal the language setting of the registered component, the language manager 160 executes a method on the component to notify the registered component that the current language setting has changed. The component will then retrieve the language sensitive parameters from the language manager 160. The change language method may be, for example, a method in a Java interface class which is implemented by all components that are language sensitive.

After any necessary language changes are made to GUI components 52-60, the toolkit 150 displays the updated components 52-60 for the user. Those skilled in the art will understand that not every component may need to be registered with the language manager 160. For example, a component may not have any language sensitive properties, and therefore remains unaffected by any language changes. In such a case, the component may or may not register with the language manager 160.

FIG. 7b is an exemplary diagram showing the interaction between the language manager 160, GUI 50, and the toolkit 150 when GUI 50 is being made undisplayable to a user. When a GUI component is being removed from the screen, for example, after the user has manipulated the components 52-60 (e.g., selecting options, entering text, etc.) and activated the button 58 to proceed to the next GUI screen, the toolkit 150 executes a method to instruct the components to no longer be visible to the user. An exemplary method that performs such a function is the Java method removeNotify( ). In addition, each of the components 52-60 also de-register from the language manager 160. The following is an exemplary method that may be implemented to de-register components from the language manager 160. The method removeNotify( ) of the component is overridden so that it performs the component de-registration with the language manager 160.

public void removeNotify() {

super.removeNotify();
langMgr.removeLanguageChangedListener( this );

}

This method of the component may be automatically called by the toolkit when the component is to be undisplayed. The code of interest is the second line of the method where the component de-registers with the language manager 160 as a listener to language change events. The language manager 160 then removes this component from its list of listeners which are to be notified if a language change occurs. The language manager 160 also sets the language of the component to be undisplayed. The next time this component is to be displayed, the language manager 160 compares the language setting of the component with that of the application. If the settings are different, the language manager invokes the change language method on the component as described above.

The language manager 160 keep a list of registered components that is updated every time a new screen is displayed. Thus, when the button 58 of GUI 50 is activated by the user, the language manager 160 prepares for the next GUI screen to be displayed. Components (e.g., components 52-60) that are currently registered on the list of listeners of the language manager 160 are removed from the list of listeners using the above described methods. The new components that will be visible on the next screen are then registered and added to the list of listeners of the language manager 160 using the methods described above.

A user may change the current language setting through an option made available via, for example, one of the components visible on the GUI 50. If the user changes the selected language, this information will be relayed to the language manager 160 so it may execute the language change method on the currently registered components. The screen may then be redisplayed in a language selected by the user. Because the language change method is performed on a component by component basis based on registration with the language manager 160, a user can dynamically change the selected language at any time during the application program execution. Thus, a user is not bound by an initial language selection. Additionally, since the language change method is only executed on visible components, system resources, such as CPU time, are not wasted in changing the language of components that are not currently visible to the user.

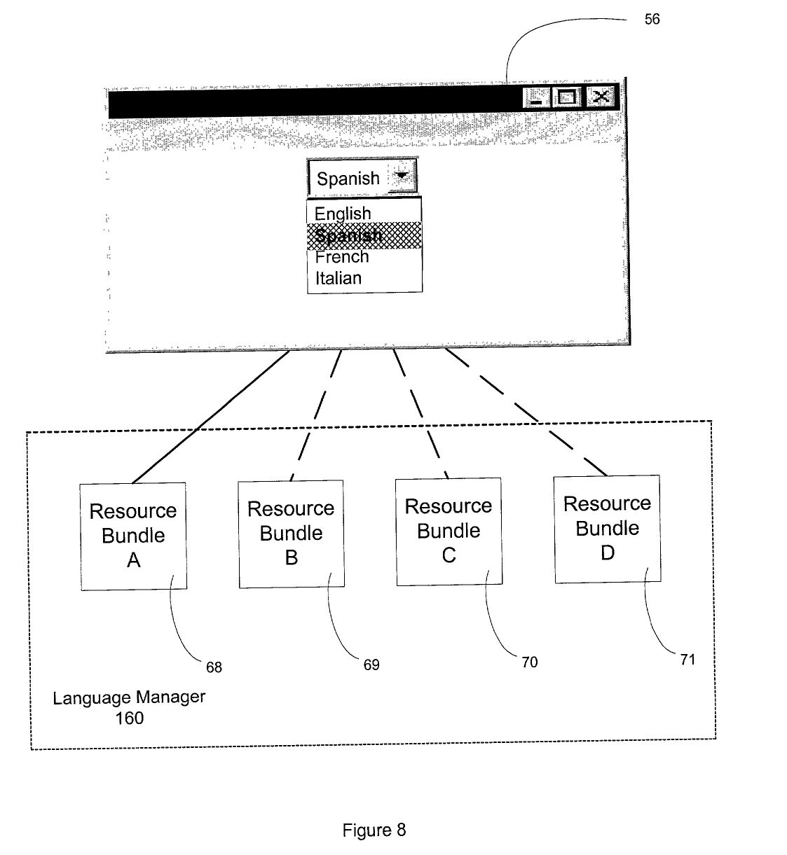

FIG. 8 shows an exemplary pull down menu 56 component that may be displayed on the GUI 50 which allows the user to change the current language setting. The pull down menu 56 contains four possible language settings for the application program, i.e., English, Spanish, French, and Italian. Those skilled in the art will understand that the language options may be displayed in various manners (e.g., checkboxes, scroll bar menus, etc.). Each language selection is related to one of the resource bundles 68-71. A resource bundle contains a set of parameters that each of the GUI components may access to obtain language specific parameters. Each language sensitive component is tied to one or more resource bundles that contain the language specific information for that GUI component. There may also be multiple resource bundles for each supported language.

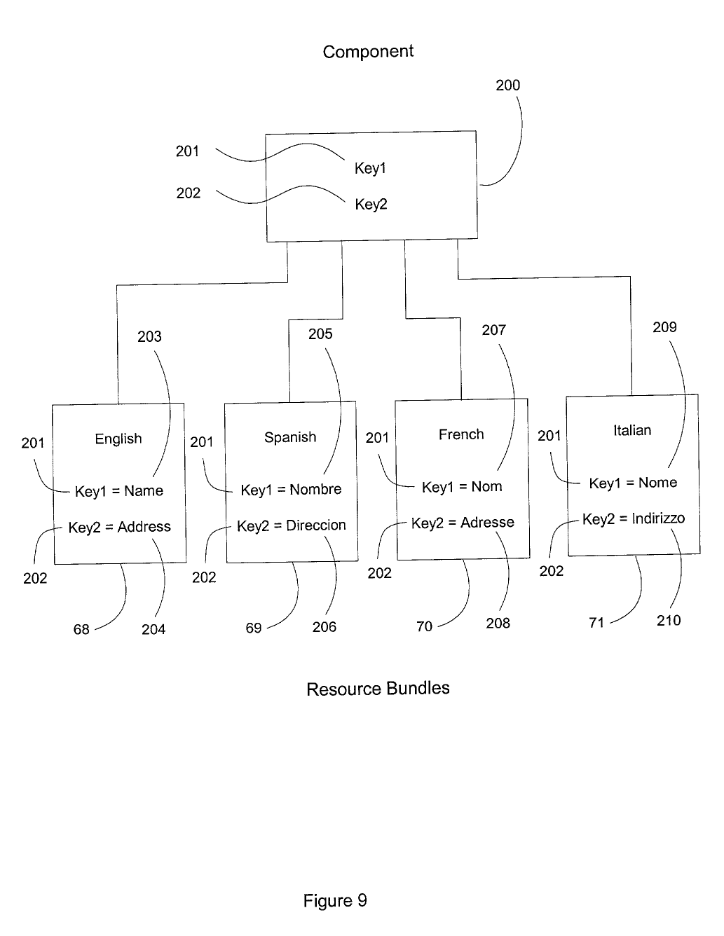

FIG. 9 shows an exemplary language sensitive GUI component 200 that may access resource bundles 68-71. Each of the resource bundles 68-71 contains a set of parameter keys 201 and 202 and corresponding values 203-210. In this example, the values 203-210 are the corresponding words for “name” and “address” in each of the four languages represented by the resource bundles 68-71. The GUI component 200 also has parameter keys 201 and 202 which are language sensitive parameters. If the current language is changed, the GUI component 200 will access the corresponding resource bundle 68-71 and load the values 203-210 for that resource bundle 68-71. The text or image displayed in the GUI component 200 is the value 203-210 for the loaded resource bundle 68-71.

The GUI component 200 may also query for the values through the language manager 160 (not shown in FIG. 9). In this case, the language manager 160 may load the proper resource bundles based on the current language setting of the application. When a GUI component 200 retrieves the values through the language manager 160, the GUI component is not aware from which resource bundle the value is being retrieved because the current language resource bundle(s) is the only bundle that is loaded and accessible.

Parameter keys 201 and 202 may be any word selected by the developer and will generally relate to some functionality. As a result, an English developer is likely to select English word parameter keys which have some functional relation to the text that is displayed in GUI component 200. For example, instead of using “key1” 201 and “key2” 202, the English developer may use the words “name” and “address” for parameter keys 201 and 202, respectively. The English word parameter key, however, will only be seen by the developer. During the application program, the user sees the values 203-210 that are currently loaded into the component 200.

When GUI component 200 is displayed it will access the appropriate resource bundle 68-71 based on the current language setting for the application program. For example, if the current language is English, the GUI component 200 will display the values “Name” 203 and “Address” 204 in the area designated by key1 201 and key2 202, respectively. Similarly, if the current language setting is Spanish, the GUI component 200 will display “Nombre” 205 and “Dirección” 206 in the area designated by key1 201 and key2 202, respectively. In this example, the values 203-210 for the parameter keys 201 and 202 are shown as text strings. Those skilled in the art will understand that the values 203-210 may be other types of references that may be used to store language specific information. For example, the value may be an image file or a file reference that contain the language specific value for a parameter key.

In addition, the resource bundles 68-71 may contain parameter keys and values for all the components that may be displayed for an application program. For example, an application program may have ten (10) GUI screens, each of which has five (5) components with language sensitive properties. Thus, the application program has fifty (50) components with language sensitive properties. Continuing with the example, each of the fifty (50) components may have five (5) language parameters resulting in a total of two-hundred-fifty (250) language parameters for the application program. There may be two-hundred-fifty (250) parameter keys for these language parameters. Thus, each of the resource bundles 68-71 may contain the two-hundred-fifty (250) parameter keys and corresponding values for the parameter keys. Those skilled in the art will understand that a GUI component may be used in multiple GuIs within an application program. Additionally, a parameter key may be used for multiple components. For example, the word “name” may appear as a language sensitive parameter in multiple GUI components. However, there is no need for multiple parameter keys of the same word, each of the GUI components implementing the word “name” may use the same parameter key to retrieve the appropriate value to be displayed.

In one exemplary embodiment of the configuration shown in FIG. 8, bundle A 68 represents English, bundle B 69 represents Spanish, bundle C 70 represents French, and bundle D 71 represents Italian. Bundle A 68 is originally loaded into the application since English is the default language. If during the course of the program Spanish is selected, the language manager causes bundle B 69 to be loaded. If the pull down menu 56 component is registered as a listener with the language manager, then the pull down menu 56 is instructed to change its language, the values 205 and 206 for bundle B 69 are then loaded into the pull down menu 56 and displayed to the user.

In one exemplary embodiment, a screen may be designed to contain GUI components that have no language sensitive properties. In this embodiment, no components would be on the list of listeners and no components would be instructed to change languages. Language changes would not affect any components in the application until the user proceeds to a point within the application program that displays one or more GUI components with language sensitive properties. The language manager would then register the component on the list of the listeners and, if the language of the component is different than the current language, the language manager would instruct the component to change to the current language.

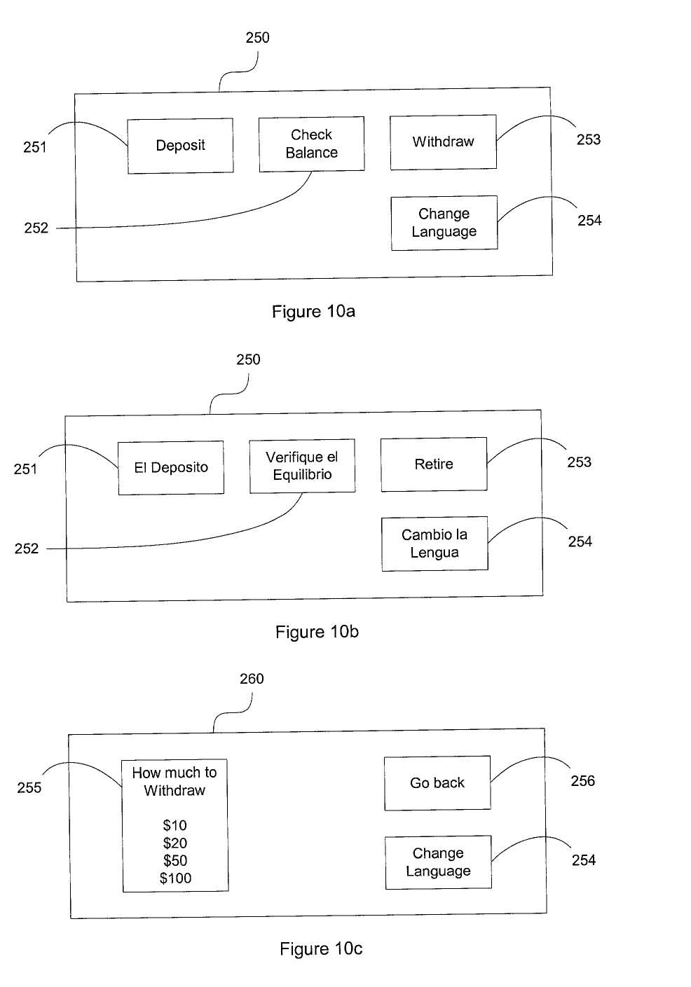

FIGS. 10a, 10b, and 10c show another exemplary embodiment, in which the application program may be used to help a user access an automated teller machine (“ATM”). GUI 250 in FIG. 10a and 10b both display the same components 251-254; FIG. 10a is shown with the current language set to English and FIG. 10b is shown with the current language set to Spanish. FIG. 10c is a GUI 260, shown in English, that may be displayed after the user activates the withdraw GUI component 253. The GUI 250 may prompt the user to indicate which type of transaction the user would like to complete (e.g., deposit, check balance, withdraw). The GUI 250 may contain three components 251-253 for the three transaction options and a separate GUI component 254 for allowing the user to change the display language. Those skilled in the art will understand that each GUI screen does not need to have a change language component. For example, the user may be instructed that a keypad key or sequence of keys may be used to change the language during the execution of the application program. The withdraw GUI component 253 has a parameter key and a value, as described above. The parameter key may be “withdraw”, “withdraw money”, “key1”, or any other word chosen by the developer. The word chosen to represent the parameter key would be the same for each resource bundle associated with the application program. The value of the key in the English resource bundle would be “withdraw”. The value for any other resource bundle would be a translation of “withdraw” in the language represented by the resource bundle. For example, if the ATM program was designed to have Spanish resource bundles, “retire” would be the value for the withdraw money GUI component. FIG. 10b shows an example of the GUI 250 with Spanish values. The parameter keys for the three GUI components 251-253 remain the same and the components 251-253 perform the same functions as they would if they were displayed in English (FIG. 10a)

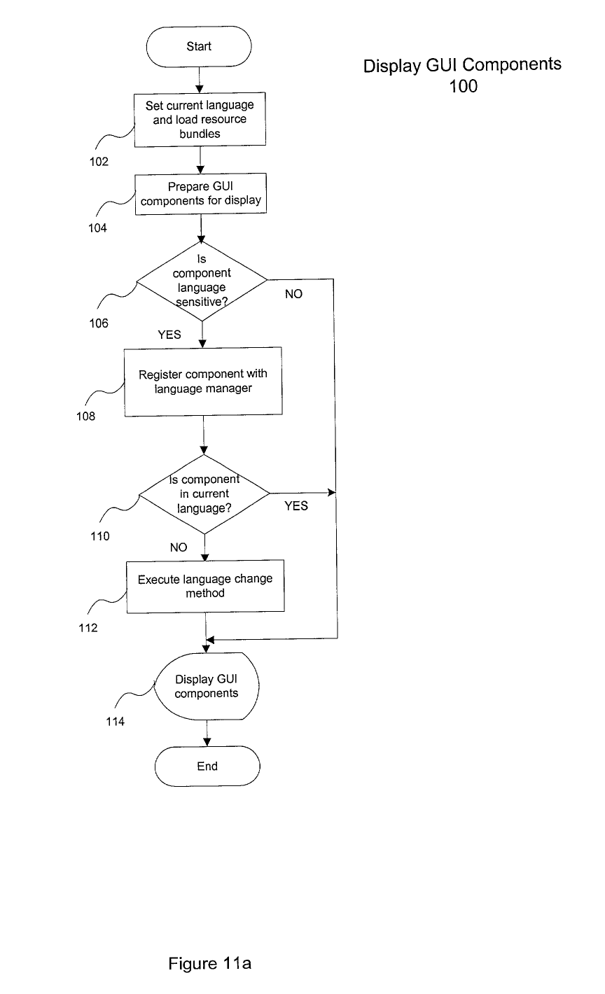

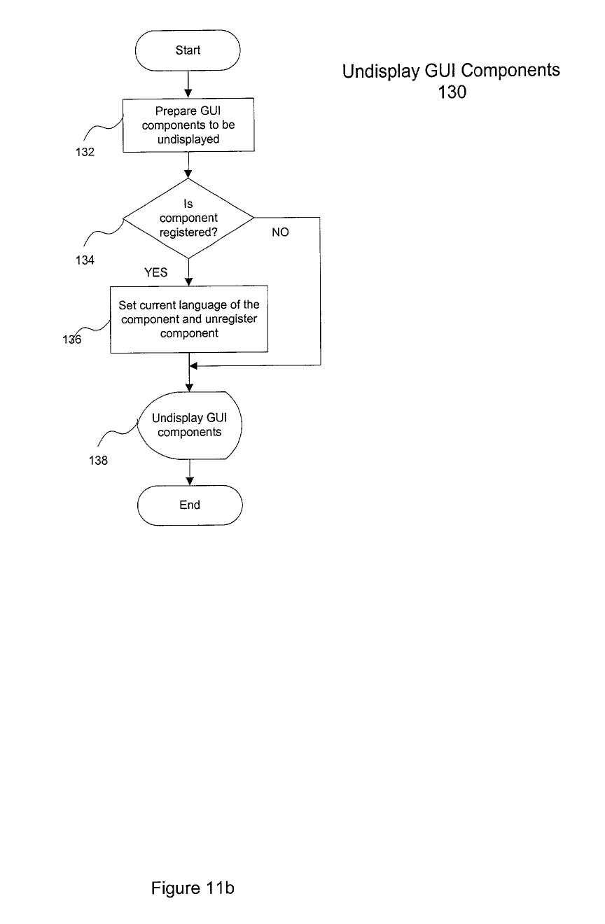

FIG. 11a shows an exemplary process 100 for displaying GUI components that may have their language changed. The exemplary process 100 will be described with reference to FIGS. 10a, 10b, and 10c, which show exemplary GUI 250 and GUI 260 having language sensitive components 251, 252, 253, 254, 255, and 256. When the application program containing GUI 250 is initially started, it may have a default language set and a resource bundle(s) corresponding to the default language would be loaded so the application program can display the initial GUI in the default language. The user or developer may change this default language when operating the application program via well known methods. In the alternative, the first GUI that is displayed after loading an application program may be a GUI that allows the user to initially select the current language.

In step 102, the current language is set to the default language or the language selected by the user (depending on the scenario implemented by the particular application program as described above) and the resource bundle(s) for the selected language is loaded and available to the GUI components. As will be described in greater detail below, only resource bundle(s) corresponding to the current language needs will be loaded at any particular time. This saves system resources, such as RAM, because instead of loading all possible values for language parameters (i.e., all resources bundles), only those associated with the current language are loaded.

In step 104, the toolkit calls the method addNotify( ) on the next set of GUI components to be displayed. In the example of GUI 250 of FIG. 10a, the toolkit would call the method on the four components 251-254 that are to be displayed on GUI 250. The process then continues to step 106 to determine if the component is language sensitive. If a component is not language sensitive then it will not have overridden the addNotify( ) method and the component will not register with the language manager. If there are language sensitive components, the process continues to step 108 where the GUI components 251-254 are registered with the language manager. Thus, at the completion of step 108, each of the language sensitive components (e.g. components 251-254) are registered as listeners of the language manager.

The process then continues to step 110, where the language manager determines whether the currently registered components are set to the current language. For example, if the current language is set to English, the language manager determines whether the components 251-254 of GUI 250 are set to display in English. If the components are not set to the current language, the process continues to step 112 where the method to change the language is executed on the components so their language is set to the current language. This language change method was described above. For example, if the current language was English, but the language of component 251 was set to Spanish, GUI 250 would display “El Deposito” rather than the desired “Deposit.” When the language change method is executed on component 251, its language is set to the current language (e.g., English) and the component goes to the English resource bundle and retrieves the value for this parameter in English (e.g., Deposit). When all the subcomponents of a component have retrieved the values for the language sensitive parameters from the resource bundle(s), the toolkit causes the component to be displayed to the user (step 114). The user may then continue using the application program (e.g., deposit, check balance, withdraw, change language) by using an input device, as described above, to interact with the GUI components.

FIG. 11b shows an exemplary process 130 for undisplaying GUI components. In step 132 the toolkit prepares the component to be undisplayed by calling the removeNotify( ) method for each component that is to be undisplayed. The process then continues to step 134 where it is determined whether the component is registered with the language manager. If the component is not registered with the language manager the process continues to step 138 where the component is undisplayed. If the component is registered with the language manager, the process continues to step 136 where the language manager sets the language of the component to the current language setting of the application and removes the component from the list of listeners. The component is then undisplayed in step 138.

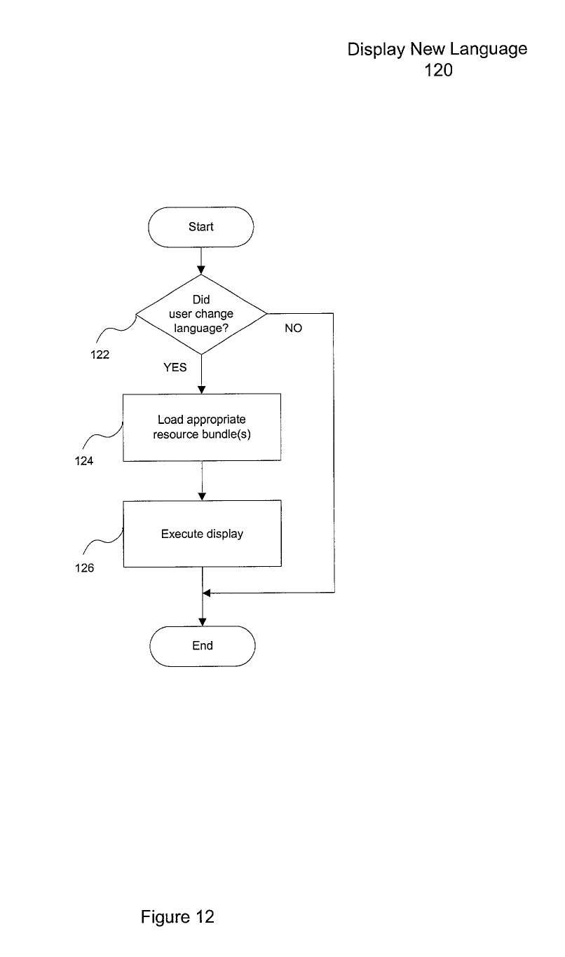

FIG. 12 shows an exemplary process 120 for displaying a new language according to the present invention. During the running of the application program, the user may select to change the display language by, for example, activating the change language GUI component 254. In step 122, the language manager 160 monitors the user interaction to see if a new language is selected. If a new language is selected, the resource bundle(s) associated with the new language is loaded (step 124). For example, referring to FIG. 8, if a user selects Spanish, resource bundle 69 would be loaded into the system so that GUI components may access the Spanish values for parameter keys. This manner of having only resource bundles for the current language loaded at a time, rather than resource bundles for multiple languages, allows for the components to retrieve the values for parameter keys from only the currently relevant resource bundle(s). Thus, the component does not have to know which bundle(s) to access, it may only access the bundle(s) that are currently loaded. Additionally, the memory footprint of resource bundle(s) for one language may be significantly less than resource bundles for all the available languages, while the system still supports multiple languages. After the new resource bundle(s) are loaded, the process continues to step 126 where the application program may execute a display method, for example, the process 100 described with reference to FIG. 11a, so the user may see the current GUI displayed in the selected language.

FIGS. 10a-b maybe used as an example of the process 120 of FIG. 12. The application program may be currently displaying GUI 250 of FIG. 10a in English. The user may select the change language component 254 and select Spanish as the new language. The language manager will receive this change (step 122) and load the Spanish resource bundle(s) in exchange for the English resource bundle(s) (step 124). GUI 250 would then have to be redisplayed in Spanish as shown in FIG. 10b.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising the steps of:
setting a language for an application;
registering components on a list of listeners when the components are to be displayed by the application, wherein the components have a language setting;
changing the language setting of each component on the list of listeners to the language for the application when the language setting is different from the language for the application; and
displaying the components in the language for the application.

2. The method according to claim 1, further comprising the step of:
removing the components from the list of listeners when the component is finished being displayed by the application.

3. The method according to claim 1, further comprising the steps of:
resetting the language for the application to a new language; and
repeating the changing step.

4. The method according to claim 1, wherein only components including language sensitive properties are registered to the list of listeners.

5. A method, comprising the steps of:
registering a graphical user interface component with a language manager;
changing a language setting of the component to a first language contained in the language manager when the component is registered with the language manager; and
displaying the component in the first language contained in the language manager.

6. The method according to claim 5, further comprising the steps of:
changing the language setting of the component to a second language contained in the language manager; and
displaying the component in the second language contained in the language manager.

7. The method according to claim 6, further comprising the step of:
receiving an instruction to change the language setting of the component to the second language contained in the language manager.

8. The method according to claim 5, further comprising the step of:
de-registering the component from the language manager when the component is finished being displayed.

9. The method according to claim 5, wherein the registering step is performed when the component is to be displayed.

10. A system, comprising:
a plurality of resource bundles containing language specific information, each set of resource bundles corresponding to a predetermined language;
a graphical user interface component to be displayed on an output arrangement, wherein the component retrieves language specific information from the plurality of resource bundles; and
a language manager containing a language setting for an application, wherein the component is registered with the language manager when the component is to be displayed and the language manager provides the component with access to the set of resource bundles corresponding to the language setting.

11. The system according to claim 10, wherein one of a user and the application may change the language setting.

12. The system according to claim 10, wherein the language setting is a default language for the application.

13. The system according to claim 10, wherein the component is de-registered from the language manager when it is finished being displayed.

14. The system according to claim 10, wherein the resource bundles and the component include a corresponding parameter key, a value of the parameter key is the language specific information in each of the resource bundles, and the component obtains the value from the set of resource bundles corresponding to the language setting in the language manager.

15. The system according to claim 10, wherein when the language setting is changed, the language manager provides the component with access to the set of resource bundles corresponding to a new language setting.
